(19) United States
(12) Patent Application Publication
(10) Pub. No.: US 2011/0048989 A1
(43) Pub. Date: Mar. 3, 2011

(54) WRENCH AND SOCKET HOLDER

(76) Inventor: Stanley D. Winnard, Carrollton, TX (US)

(21) Appl. No.: 12/873,451

(22) Filed: Sep. 1, 2010

Related U.S. Application Data
(60) Provisional application No. 61/238,947, filed on Sep. 1, 2009.

(51) Int. Cl. B25H 3/00; B65D 85/20

(52) U.S. Cl. 206/378; 206/349

(57) ABSTRACT

The present invention provides a socket holder for engaging and optionally locking one or more wrench socket. The socket holder comprises a base member with a plurality of attached slidable individual socket holders of varied shapes and dimensions. The individual socket holders are capable of movement along the length of the base member.

### CROSS-REFERENCE TO RELATED APPLICATIONS

This application claims priority to U.S. Provisional Application Ser. No. 61/238,947, filed Sep. 1, 2009, the content of which is incorporated by reference herein in its entirety.

### TECHNICAL FIELD OF THE INVENTION

The present invention relates in general to the field of socket holders and, in particular, to a socket holder comprising a base member with a plurality of slidable individual socket holders of varied shapes and dimensions, capable of engaging and locking a socket of the corresponding shape and dimension.

### BACKGROUND OF THE INVENTION

Without limiting the scope of the invention, its background is described in connection with socket holders and related devices.

U.S. Pat. No. 4,927,020 issued to Randy (1990) discloses a storage and organizer holder for detachable socket wrench heads of the polygonal socket types, the holder including a base member with several parallel rows of dove-tailed slots in which a plurality of cross sectionally square posts having dove-tailed shaped downward extensions are slidably and frictionally engaged. The dimensions of the cross sectionally square posts are varied so as to correspond to the standard drive dimensions of the socket wrench sets and are preferably positioned in the dove-tailed slots of the base member of the holder in groups corresponding with each of the different sizes of the standard drive dimensions of the socket wrench sets.

U.S. Pat. No. 5,743,395 issued to Backer (1998) discloses a socket holder for a plurality of socket wrench sockets has studs projecting from a top surface, each of the studs being sized and shaped closely uniquely to engage a particular socket so that the socket on a stud will not be accidentally dislodged, and the stud can be used to measure a nut or the head of a bolt before the socket is employed. The studs are accompanied by indicia of size.

U.S. Pat. No. 6,092,655 issued to Ernst (2000) discloses a wrench socket holder that includes a post structure on which may be received a wrench socket. According to the '655 patent a flexible arm adjacent the post carries a boss which seats in a recess commonly found in internal socket walls and otherwise utilized for drive stud retention. A resilient member extends intermediate the post and arm to urge the latter toward engagement with a socket thereon to insure retention of the socket against all but intentional removal. A base of the socket holder may be shaped for sliding engagement with an elongate guideway or an elongate surface for the reception of several socket holders. A modified form of socket holder dispenses with a resilient member and relies on resiliency of the arm for socket retention. A multitude of socket holders may be supported by a common base on which several semicircular socket receptacles are formed with the holders preventing undesired socket separation from the holder.

### SUMMARY OF THE INVENTION

The present invention provides a socket holder for wrench or ratchet sockets or varied shapes and dimensions. The socket holder of the present invention comprises a base member and a plurality of individual socket holders of varied shapes and dimensions. The individual socket holders can be added or removed from the base member and are slidable along the length of the base member. The individual socket holders can engage and optionally lock the socket of the corresponding shape and dimension.

The present invention provides a socket holder for receiving, engaging, fitting, and optionally locking with a size-on-size fit the one or more wrench or ratchet sockets having a base, wherein the base is rectangular, square shapes, circular, oval, polygonal, octagonal or any combinations thereof, and is capable of movement in a parallel direction along a lower surface of a base member; one or more studs attached to the base, wherein the stud is a circular stud, a rectangular stud, an oval stud, an octagonal stud, a polygonal stud, a square stud and receives, engages, fits, and optionally locks with a size-on-size fit the one or more wrench or ratchet sockets; and one or more optional holes attached to the stud for attaching and locking the one or more wrench or ratchet sockets to the stud.

The present invention provides a device for organizing and holding one or more individual wrench or ratchet sockets having a flat base member having an upper and a lower surface with one or more transversely parallel dove-tailed grooves in the upper surface; and one or more individual socket holders comprising a base and a stud, wherein the base slides along and fits the lower surface of the flat base member in a parallel direction and the stud is a circular stud, a rectangular stud, an oval stud, an octagonal stud, a polygonal stud, a square stud and receives, engages, fits, and optionally locks with a size-on-size fit the one or more wrench or ratchet sockets.

### BRIEF DESCRIPTION OF THE DRAWINGS

For a more complete understanding of the features and advantages of the present invention, reference is now made to the detailed description of the invention along with the accompanying figures and in which:

FIG. 1 shows a perspective view of an individual slidable socket holder of the present invention;

FIG. 2 shows a perspective view of an individual slidable socket holder of the present invention;

FIG. 3 shows a perspective view of an individual slidable socket holder of the present invention;

FIGS. 4A and 4B shows the individual slidable socket holder engaging a circular socket according to an embodiment of the present invention;

FIGS. 5A and 5B shows the individual slidable socket holder engaging a rectangular socket according to an embodiment of the present invention;

FIG. 6A shows the individual slidable socket holder of the present invention engaging an octagonal socket according to an embodiment of the present invention;

FIG. 6B is a top view of FIG. 6A without the opening for attaching a screw;

FIG. 7 shows the individual slidable socket holder of the present invention engaging an circular socket according to an embodiment of the present invention; and

FIGS. 8A and 8B shows the base member with a groove for accommodating the slidable socket holder of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention is a socket holder comprising a base member with a plurality of slidable individual socket holders of varied shapes and dimensions, capable of engaging and locking a socket of the corresponding shape and dimension.

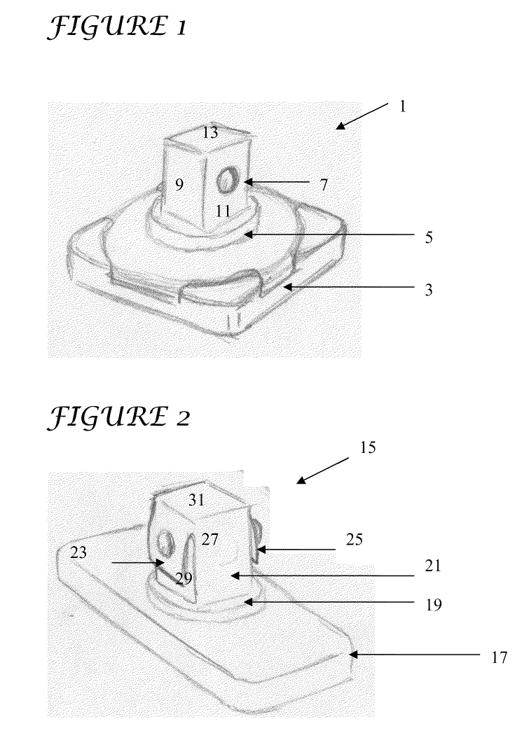

FIG. 1 shows an individual socket holder 1 of the present invention. The socket holder comprises a square shaped base 3 that slides on the base member (not shown). The base 3 has a raised circular portion 5 in the center which attaches a rectangular socket holding stud 7. FIG. 1 shows two sides 9 and 11 of the stud 7. The top side 13 of stud 7 is also shown. The base (not shown) is flush and fused to the circular portion 5. The two other sides of the holding stud 7 are not shown in FIG. 1. The stud 7 slides into the hollow rectangular cavity of a circular or rectangular socket, and can optionally engage and lock the said socket.

FIG. 2 shows an individual socket holder 15 of the present invention. The socket holder comprises a rectangular base 17 that slides on the base member (not shown). The base 17 has a raised circular portion 19 in the center which attaches a rectangular socket holding stud 21. FIG. 2 shows two sides 27 and 29 of the stud 21. The top side 31 of stud 21 is also shown. The base (not shown) is flush and fused to the circular portion 19. The two other sides of the holding stud 21 are not shown in FIG. 2. The stud 21 slides into the hollow rectangular cavity of a circular or rectangular socket. The two flaps 23 and 25 attached to side 27 and to a side not shown in FIG. 2 are used to engage and lock the said socket.

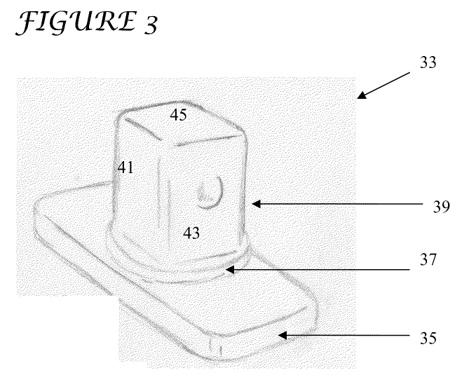

FIG. 3 shows an individual socket holder 33 of the present invention. The socket holder comprises a rectangular base 35 that slides on the base member (not shown). The base 35 has a raised circular portion 37 in the center which attaches a rectangular socket holding stud 39. FIG. 3 shows two sides 41 and 43 of the stud 39. The top side 45 of stud 39 is also shown. The base (not shown) is flush and fused to the circular portion 37. The two other sides of the holding stud 39 are not shown in FIG. 3. The stud 39 slides into the hollow rectangular cavity of a circular or rectangular socket, and can optionally engage and lock the said socket.

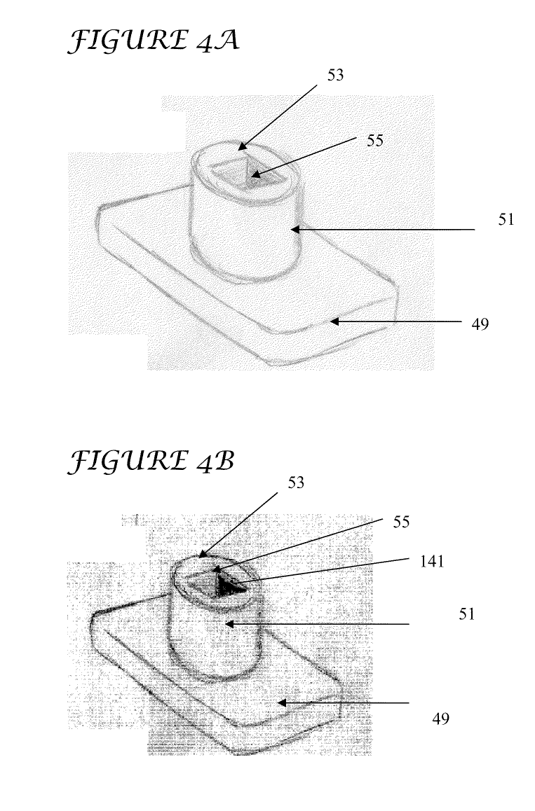

FIGS. 4A and 4B show a rectangular slot to one according to an embodiment of the present invention without and with respectively two flaps attached to side to engage and lock the said shaft. The oval shaped socket 51 has a face (or a base which attached to a ratchet or wrench) 53 and a hollow cavity rectangular cavity 55 that runs the entire length of the socket 51. The rectangular stud of the socket holder (not shown) slides into the hollow rectangular cavity 55 to hold the socket 51. The base of the socket holder 49 that has the stud and which slides on a base member (not shown) is also shown in FIG. 4.

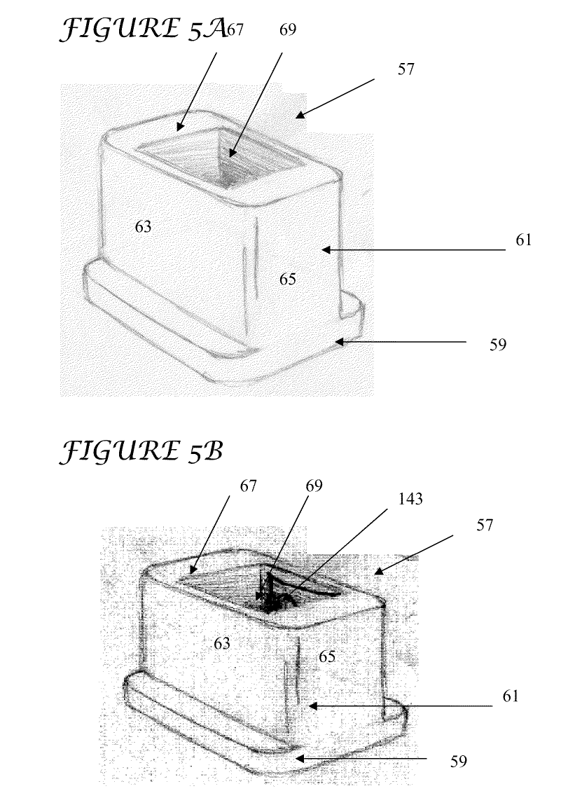

FIGS. 5A and 5B show a rectangular slot to one according to an embodiment of the present invention without and with respectively two flaps attached to side to engage and lock the said shaft. The socket holder has a base 57 that has the rectangular stud that engages the socket 61 and that slides on a base member (not shown). Only two of the four sides 63 and 65 of the socket are shown. The socket 61 has a face (or a base which attached to a ratchet or wrench) 67 and a hollow cavity rectangular cavity 69 that runs the entire length of the socket 61. The rectangular stud of the socket holder (not shown) slides into the hollow rectangular cavity 69 to hold the socket 61.

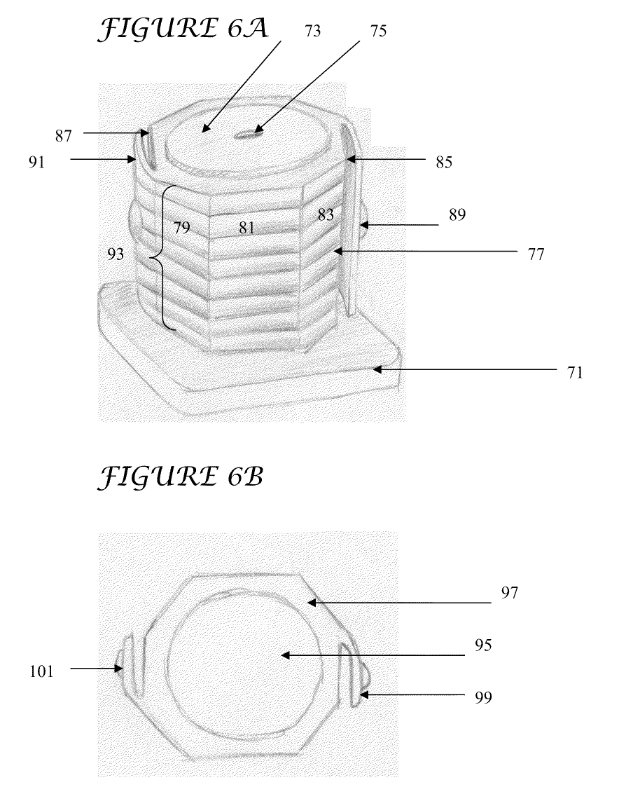

FIG. 6A shows an octagonal shaped socket 77, held by a circular stud 73 (only the top portion shown) supported on a base 71 that slides in an out of a base member (not shown). The octagonal shaped stud 77 can be optionally locked in place by a screw. The opening 75 is provided for attaching the screw to the circular stud 73. The circular stud 73 can engage sockets of any shape provided they have a hollow circular cavity, but in FIG. 6A it engages an octagonal socket 77 with a hollow cavity. Only five (79, 81, 83, 85, and 87) out of the eight sides of socket 77 are shown in FIG. 6A. The octagonal socket 77 has two flaps or grooves 89 and 91, on the outer surface attached at an angle to the two opposite sides 85 and 87, respectively that may be used to attach and lock the socket 77 to a ratchet or wrench. The socket 77 has a plurality of rectangular segments or markings 93 running the outer entire circumference of the socket 77.

FIG. 6B shows is a top view showing the top portion of a circular stud 95, engaging an octagonal socket 97 (top portion of the socket shown). The octagonal socket 97 has two grooves 99 and 101 attached at an angle to two opposite sides that may be used to attach and lock the socket 97 to a ratchet or wrench.

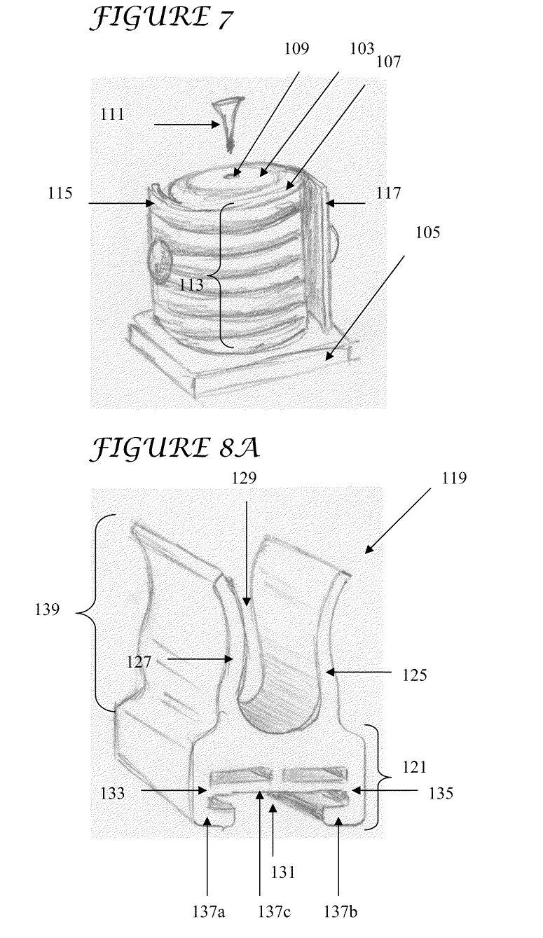

FIG. 7 shows a circular socket 107, held by a circular stud 103 (only the top portion shown) supported on a base 105 that slides in an out of a base member (not shown). The octagonal shaped stud 103 can be optionally locked in place by a screw 111. The opening 109 is provided for attaching the screw 111 to the circular stud 103. The circular stud 103 can engage sockets of any shape provided they have a hollow circular cavity, but in FIG. 7 it engages a circular socket 107 with a hollow cavity. The circular socket 107 has two flaps or grooves 115 and 117, on the outer surface (circumference) attached at an angle that may be used to attach and lock the socket 107 to a ratchet or wrench. The socket 107 has a plurality of rectangular segments or markings 113 running the outer entire circumference of the socket 107.

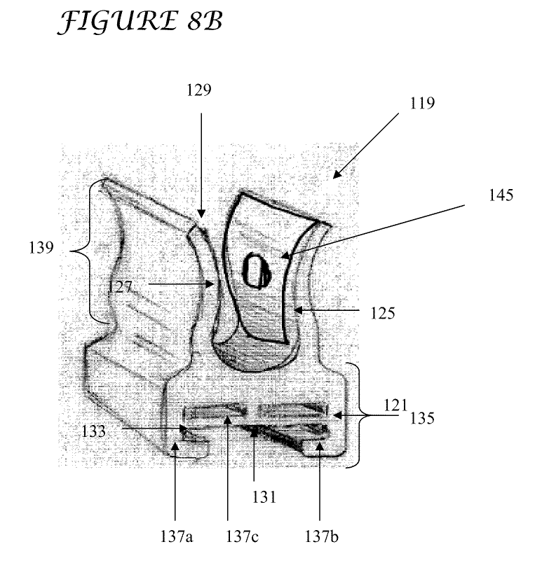

FIGS. 8A and 8B show a rectangular slot to 1 according to an embodiment of the present invention without and with respectively two flaps attached to side to engage and lock the said shaft. FIG. 8 shows a base member 119 comprising a rectangular top portion 121 and a bottom portion 139 comprising two legs 125 and 127 enclosing a gap 129. The base member 119 can be attached to a solid support by welding the legs 125 and 127, or a can be attached or placed on a rod or a similar structure through the gap 129. The rectangular top portion has two sides 133 and 135, one of the sides is not distinct and is continuous with the bottom portion 139. The top side of the rectangular top portion 121 is partially cut to have a rectangular cavity 131. The individual socket holders slide along the rectangular cavity 131 and are supported and held in place by the base 137c of the cavity 131 and the remaining uncut portions 137a and 137b of the top side of the rectangular top portion 121.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A device for organizing and holding one or more individual wrench or ratchet sockets comprising:
a generally flat base member having an upper surface, a lower surface and one or more side walls connecting the upper surface and the lower surface to form a channel there between;
a slot formed in the upper surface and extending to one or more edges; and
one or more individual socket holders comprising a base positioned at least partially within the channel and a stud extending through the slot, wherein the base slides fits the channel and slides along the lower surface of the flat base member in a parallel direction and the stud is has a shape that is a generally circular stud, a rectangular stud, an oval stud, an octagonal stud, a polygonal stud, a square stud and receives, engages, fits, and optionally locks with a size-on-size fit the one or more wrench or ratchet sockets.

2. The device of claim 1, wherein the base member is constructed from a metal, an alloy, a plastic, a composite material or any combinations thereof.

3. The device of claim 1, wherein the one or more individual socket holders are constructed from a metal, an alloy, a plastic, a composite material or any combinations thereof.

4. The device of claim 1, wherein the stud has a contour that has a tapered shape, hour glass shaped, a rectangle, a circle, a square, an oval, a polygon, an octagon, or any combinations thereof.

5. The device of claim 1, wherein the individual wrench or ratchet sockets have a cavity.

6. The device of claim 5, wherein the cavity is a rectangular cavity, a circular cavity, a square cavity, an oval cavity, a polygonal cavity, an octagonal cavity, or any combinations thereof.

7. The device of claim 1, wherein the studs pass through the cavity to engage, fit, and lock the individual wrench or ratchet sockets.

8. The device of claim 1, wherein the individual studs optionally lock the one or more individual wrench or ratchet sockets by a clockwise or counter-clockwise rotation of the sockets or by attaching a screw passing through the studs.

9. The device of claim 1, wherein the base member holds 1, 2, 3, 4, 5, 6, 7, 8, 9, 10, 20, 25, 30, 50, 75, or more individual socket holders with rectangular, circular, square, oval, polygonal, octagonal, studs or any combinations thereof.

10. The device of claim 1, wherein the device is free-standing.

11. The device of claim 1, wherein the device is contained in a tool-kit.

12. The device of claim 1, wherein the device is mounted on a wall or a shelf.

13. An individual socket holder for receiving, engaging, storing, and optionally locking one or more sockets comprising:
a base having a top surface and a bottom surface that form a pair of side edges and a pair of front edge and a back edge about the base, wherein the side edges are configured to slidably engage a holder device;
a stud that extends from the base having a stud profile and a stud cross section that secures the aperture of a socket to the stud.

14. The device of claim 13, wherein the base has a shape that is square, round, oval, a polygon, an octagon, or any combinations thereof.

15. The device of claim 13, wherein the stud profile is selected from a tapered shape, hour glass shaped, a rectangle, a circle, a square, an oval, a polygon, an octagon, or a combinations thereof and the stud cross section is selected from a square, round, oval, a polygon, an octagon, or a combinations thereof.

16. The device of claim 13, wherein the stud has a diameter to fit a ⅛, ¼, ⅜, ½, ⅝, ¾, 1″ or other common driver size.

17. The device of claim 13, wherein the stud has a diameter that provides a one size to fit a ⅛, ¼, ⅜, ½, ¾, and 1″ driver size.

18. The device of claim 13, wherein the base member has an upper and a lower surface with one or more transversely parallel dove-tailed grooves in the upper surface.

19. The device of claim 13, wherein the individual socket holder is constructed from a metal, an alloy, a plastic, a composite material or any combinations thereof

20. The device of claim 13, wherein further comprising an aperture in the top of the stud that receives a pin that penetrated the aperture to engage, fit, and lock the individual socket to the stud.

21. The device of claim 13, wherein the individual studs comprises an aperture designed to receive the drive of a ratchet.

21. The device of claim 13, wherein the individual studs optionally lock the one or more individual wrench or ratchet sockets by a clockwise or counter-clockwise rotation of the sockets or by attaching a screw passing through the studs.
